(19) United States
(12) Patent Application Publication
(10) Pub. No.: US 2014/0093746 A1
(43) Pub. Date: Apr. 3, 2014

(54) MAGNETIC SEED LAYER

(71) Applicant: SEAGATE TECHNOLOGY LLC, Scotts Valley, CA (US)

(72) Inventors: Antonio Javier Zambano, San Jose, CA (US); Li Tang, Fremont, CA (US); John David Westwood, Mountain View, CA (US)

(73) Assignee: SEAGATE TECHNOLOGY LLC, Scotts Valley, CA (US)

(21) Appl. No.: 13/632,154

(22) Filed: Sep. 30, 2012

(51) Int. Cl. G11B 5/66

(52) U.S. Cl. CPC G11B 5/66
USPC 428/828; 428/832; 428/827

(57) ABSTRACT

An apparatus includes a disk substrate and a soft underlayer overlying the disk substrate. A magnetic seed layer overlies the soft underlayer, wherein the magnetic seed layer is formed by a hexagonal close-packed lattice material and has in-plane magnetic anisotropy.

### BACKGROUND

In magnetic recording media, as used in disk drive storage devices, information may be written to and read from magnetic elements that represent digital bits on a disk substrate or data storage disk. Multiple layers that are established upon such a disk may aid in the writing and reading of the magnetic elements.

A movable read/write head, for example a transducer, may perform read/write operations with the magnetic elements. The magnetic elements may be arranged in circular and concentric data tracks on the surface of one or more disks. Multiple data storage disks may be mounted in vertically spaced and parallel relation to one another on a hub or shaft that rotates about a shaft or hub of a motor, respectively.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a plan view of a data storage device in which embodiments herein be implemented.

FIG. 2 is a simplified cross-sectional view of a magnetic recording medium, which may be used for the data storage disk in an embodiment.

FIG. 3 is a simplified cross-sectional view of a portion of the magnetic recording medium with a head unit in accordance to another embodiment.

FIGS. 4a-d are exemplary graphical views of a vibrating sample magnetometer (VSM) M-H loops of Co-12Cr-15Ru grown on a soft underlayer in accordance with one embodiment.

FIG. 5 is graphical view of the noise levels of Co-12Cr-15Ru in accordance with one embodiment.

FIG. 6 depicts a flowchart 600 of an exemplary process of writing to magnetic elements according to an embodiment.

### DETAILED DESCRIPTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

For expository purposes, the term “horizontal” as used herein refers to a plane parallel to the plane or surface of an object, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

Embodiments herein provide methods and systems for using magnetic seed layers with hcp structures and in-plane magnetic anisotropy, for example, as a layer on a hard disk storage medium. It is appreciated, however, that application of embodiments herein to hard disk storage mediums is exemplary and not intended to limit the scope. For example, embodiments herein can be applied to any storage medium.

Magnetic recording media may include multiple layers. For example, magnetic recording media may include a disk substrate, soft underlayer, a seed layer, multiple interlayers, a recording layer, a protective coat layer, and a lubricant layer. Each layer may be formed by different materials with different properties. For example, a layer may be amorphous (non-crystalline) or crystalline, may have a face-centered cubic or hexagonal close-packed lattice structure, may be nonmagnetic, may be magnetic with out-of-plane (perpendicular) or in-plane (longitudinal) magnetic anisotropy, and so on. The properties of each layer may affect the performance or writability, the manufacturing process, and the cost of manufacturing of the magnetic recording media.

Seed layers may be nonmagnetic or magnetic. Magnetic seed layers may include a material with a face-centered cubic (fcc) lattice, which has no uniaxial magneto-crystalline anisotropy. For example, Ni—X alloys may be grown in [111] texture, where X is a non-magnetic alloying element. According to one embodiment, X may be a non-magnetic alloy element with impurity. However, fcc magnetic seed layers may not provide the most effective epitaxial properties to deposit subsequent hexagonal close-packed (hcp) interlayers. Further, fcc magnetic seed layers generally have low anisotropy magnetic fields (Hₖ), and limited ranges of magnetic permeability (μ) and saturated magnetic flux densities (Bₛ). Magnetic seed layers with hcp lattice structures were typically not considered because of their out-of-plane or vertical magneto-crystalline anisotropy. However, embodiments of the present invention provide magnetic seed layers with hcp lattice structures with net in-plane magnetic anisotropy.

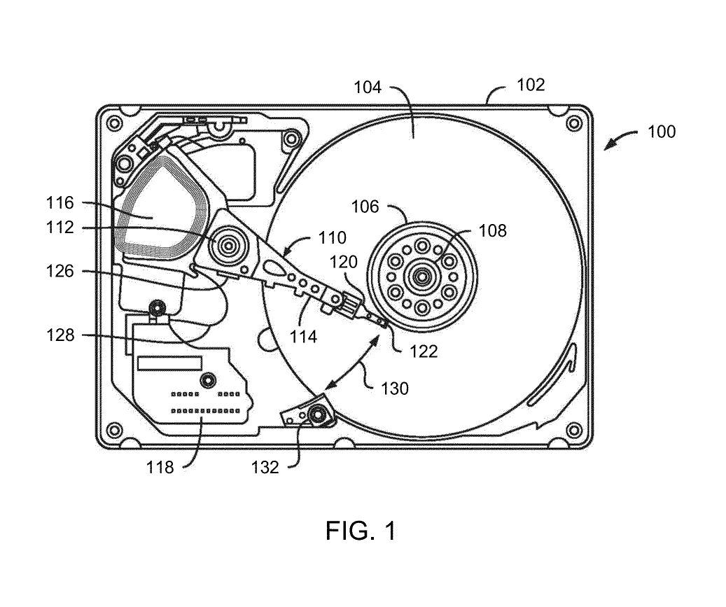

FIG. 1 is a plan view of a data storage device in which embodiments herein may be implemented. A disk drive 100 generally includes a base plate 102 and a cover (not shown) that may be disposed on the base plate 102 to define an enclosed housing for various disk drive components. The disk drive 100 includes one or more disk substrates or data storage disks 104 of computer-readable data storage media. Typically, both of the major surfaces of each data storage disk 104 include a plurality of concentrically disposed tracks for storing data. Each data storage disk 104 is mounted on a hub or spindle 106, which in turn is rotatably interconnected with the base plate 102 and/or cover. Multiple data storage disks 104 are typically mounted in vertically spaced and parallel relation with respect to one another on the spindle 106. A spindle motor 108 rotates the data storage disks 104.

The disk drive 100 also includes an actuator arm assembly 110 that pivots about a pivot bearing 112, which in turn is rotatably supported by the base plate 102 and/or cover. The actuator arm assembly 110 includes one or more individual rigid actuator arms 114 that extend out from near the pivot bearing 112. Multiple actuator arms 114 are typically disposed in vertically spaced relation, with one actuator arm 114 being provided for each major data storage surface of each data storage disk 104 of the disk drive 100. Other types of actuator arm assembly configurations could be utilized as well, e.g., an “E” block having one or more rigid actuator arm tips or the like that cantilever from a common structure. Movement of the actuator arm assembly 110 is provided by an actuator arm drive assembly, such as a voice coil motor 116 or the like. The voice coil motor 116 is a magnetic assembly that controls the operation of the actuator arm assembly 110 under the direction of control electronics 118.

A load beam or suspension 120 is attached to the free end of each actuator arm 114 and cantilevers therefrom. Typically, the suspension 120 is biased generally toward its corresponding data storage disk 104 by a spring-like force. A slider 122 is disposed at or near the free end of each suspension 120. What is commonly referred to as the read/write head (e.g., transducer) is appropriately mounted as a head unit (not shown) under the slider 122 and is used in disk drive read/write operations. The head unit under the slider 122 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 122 is connected to a preamplifier 126, which is interconnected with the control electronics 118 of the disk drive 100 by a flex cable 128 that is typically mounted on the actuator arm assembly 110. Signals are exchanged between the head unit and its corresponding data storage disk 104 for disk drive read/write operations. In this regard, the voice coil motor 116 is utilized to pivot the actuator arm assembly 110 to simultaneously move the slider 122 along a path 130 and across the corresponding data storage disk 104 to position the head unit at the appropriate position on the data storage disk 104 for disk drive read/write operations.

When the disk drive 100 is not in operation, the actuator arm assembly 110 is pivoted to a “parked position” to dispose each slider 122 generally at or beyond a perimeter of its corresponding data storage disk 104, but in any case in vertically spaced relation to its corresponding data storage disk 104. In this regard, the disk drive 100 includes a ramp assembly 132 that is disposed beyond a perimeter of the data storage disk 104 to both move the corresponding slider 122 vertically away from its corresponding data storage disk 104 and to also exert somewhat of a retaining force on the actuator arm assembly 110.

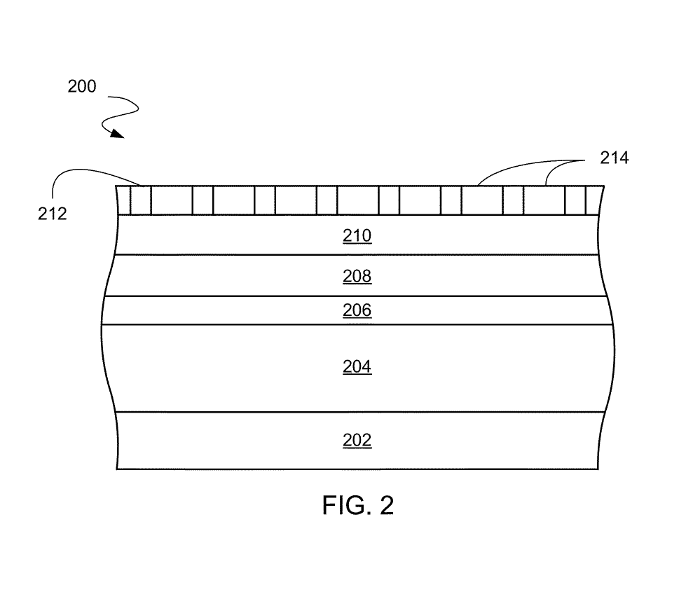

FIG. 2 is a simplified cross-sectional view of a magnetic recording medium 200, which may be used for the disk substrate or data storage disk 104 (FIG. 1). The magnetic recording medium 200 may include multiple layers deposited on a disk substrate 202.

The substrate 202 may be fabricated from materials useful for magnetic recording media for hard disk storage devices. For example, the substrate 202 may be fabricated from aluminum (Al) coated with a layer of nickel phosphorous (NiP), glass and glass-containing materials including glass-ceramics, and ceramics including crystalline, partly crystalline, and amorphous ceramics, to name a few. The substrate 202 may have a smooth surface upon which the remaining layers may be deposited.

In a further embodiment, a soft underlayer (SUL) 204 may be deposited overlying the substrate 202 and a magnetic seed layer (MSL) 206 may overly the SUL 204. The SUL 204 may be established from soft magnetic materials such as CoZrNb, CoZrTa, CoCrRu, FeCoB and FeTaC, to name a few. The SUL 204 may be formed with a high permeability and a low coercivity according to one embodiment. It is appreciated that SUL materials having coercivity of 20-50 oersteds (Oe) may be considered as having high coercivity. In an embodiment the SUL 204 may have a coercivity of not greater than about 10 Oe and a magnetic permeability of at least about 50. The SUL 204 may comprise a single SUL or multiple soft underlayers. It is appreciated that spacers may be used to separate underlayers from one another if multiple soft underlayers are used. Moreover, it is appreciated that the soft underlayers may be fabricated from the same soft magnetic material or from different soft magnetic materials if multiple soft underlayers are used. It is appreciated that the MSL 206 may be strongly coupled to the SUL 204 if 100 Å or less are grown directly on the SUL 204 that is 200 Å.

In the embodiment illustrated, the MSL 206 is disposed on the SUL 204 and may comprise at least one magnetic element such as Co, Ni, and/or Fe. Other non-magnetic metalic elements such as, for example, Cr, Ta, W, Nb, Ru, Ir, Pd, Pt, Rh, Au, or Ag may be alloyed with the magnetic material. The MSL 206 may be formed, for example, by physical vapor deposition (PVD) or chemical vapor deposition (CVD). The use of these materials may result in optimized growth properties of magnetic recording islands 214, discussed below.

As discussed above, magnetic seed layers may include a material with a face-centered cubic (fcc) lattice structure with no uniaxial magneto-crystalline anisotropy. For example, Ni—X alloys may be grown in [111] texture, where X is a non-magnetic alloying element. However, fcc magnetic seed layers may not provide the most effective epitaxial properties to deposit subsequent hexagonal close-packed (hcp) interlayers. Further, fcc magnetic seed layers generally have low anisotropy fields (Hₖ), and limited ranges of magnetic permeability (μ) and saturated magnetic flux densities (Bₛ). However, magnetic seed layers with hcp lattice structures were typically not considered because of their out-of-plane or vertical magneto-crystalline anisotropy.

In a further embodiment, at least one interlayer may be established above the MSL 206. In the embodiment illustrated, interlayers 208 and 210 overly the MSL 206. The interlayers 208 and 210 may comprise one or more non-magnetic materials that may serve to reduce or substantially prevent magnetic interactions between the SUL 204 and a base layer 212 (discussed below) in accordance with one embodiment. It is appreciated that the interlayers 208 and 210 may serve to promote microstructural and magnetic properties of the hard recording layer in one embodiment.

The interlayers 208 and 210 may optimize media performance. For example, in magnetic recording media, the interlayers 208 and 210 may be used to control the crystallographic orientation, grain size, and grain distribution of the base layer 212. The interlayers 208 and 210 may also reduce exchange coupling between magnetically hard recording layers and magnetically soft layers. It is appreciated that the interlayers 208 and 210 may provide physical separation between adjacent grains of the base layer 212 in one embodiment.

A base layer 212 may be a layer that is established above the MSL 206. In various embodiments, one or more layers (e.g. interlayers 208 and 210) may be present between the base layer 212 and the MSL 206. Magnetic recording islands 214 are recording areas that are established in the base layer 212. The magnetic recording islands 214 may be established to have an easy magnetization axis (e.g., the c-axis) that is oriented perpendicular to the surface of the magnetic recording medium 200. Magnetic recording islands 214 may be formed from material including cobalt-based alloys with a hexagonal close packed (hcp) structure. Cobalt may be alloyed with elements such as chromium (Cr), platinum (Pt), ruthenium (Ru), boron (B), niobium (Nb), tungsten (W) and tantalum (Ta), to name a few.

The magnetic recording medium 200 may also include a protective layer (not shown) on top of the base layer 212. The protective layer may comprise protective carbon layer, and a lubricant layer. These protective layers may reduce damage from the read/write head interactions with the recording medium during start/stop operations. The magnetic recording medium 200 may include additional layers not shown or described. For example, there may be an adhesion or buffer layer between the substrate layer 202 and the SUL 204. A buffer layer may be established from elements such as Tantalum (Ta).

It should be appreciated that embodiments described herein may be applied to other recording mediums as well, e.g., a longitudinal recording medium, bit-patterned media (BPM), discrete track recording (DTR), other non-magnetic recording mediums, or heat-assisted magnetic recording (HAMR).

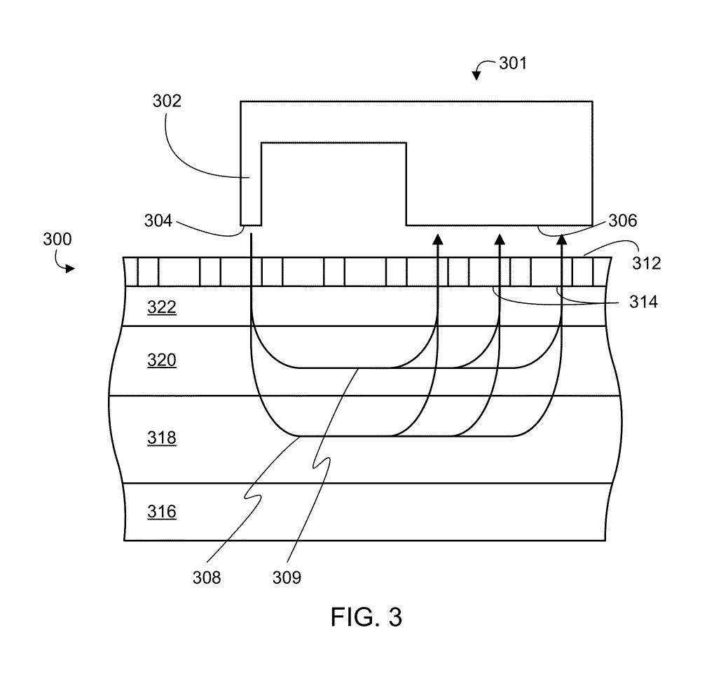

FIG. 3 shows a simplified cross-sectional view of a portion of the magnetic recording medium 300 with a head unit 301 in accordance to one embodiment. During the writing process, a perpendicular write head 302 flies or floats above the magnetic recording medium 300. The perpendicular write head 302 includes a read/write pole 304 coupled to an auxiliary pole 306. The magnetic recording medium 300 of FIG. 3 may be similar to the magnetic recording medium 200 of FIG. 2. For example, the magnetic recording medium 300 may include multiple layers formed on a disk substrate 316. The arrows shown indicate the path of magnetic flux 308 and 309, which emanates from the head/write pole 304 of the perpendicular write head 302, entering and passing through at least one magnetic recording island 314 in the region below the write pole 304, and entering and traveling within the magnetic recording medium 300 for a distance.

The substrate 316 may be fabricated from media material for use in hard disk storage devices. For example, the substrate 316 may be fabricated from aluminum (Al) coated with a layer of nickel phosphorous (NiP), glass and glass-containing materials including glass-ceramics, and ceramics including crystalline, partly crystalline, and amorphous ceramics, to name a few. The substrate 316 may have a smooth surface upon which the remaining layers may be deposited.

In various embodiments, a SUL 318 may be established overlying the substrate 316. The SUL 318 may be established from soft magnetic materials such as CoZrNb, CoZrTa, CoCrRu, FeCoB and FeTaC. The SUL 318 may be formed with a high permeability and a low coercivity. It is appreciated that a coercivity of 20-50 oersteds (Oe) may be considered as having high coercivity. In an embodiment the SUL 318 may have a coercivity of not greater than about 10 Oe and a magnetic permeability of at least about 50. The SUL 318 may comprise a single SUL or multiple soft underlayers, and may be separated by spacers. If multiple soft underlayers are present, the soft underlayers may be fabricated from the same soft magnetic material or from different soft magnetic materials.

In a further embodiment, an MSL 320 may overly the SUL 318 and at least one interlayer may be established above the MSL 320. In the embodiment illustrated, interlayer 322 may overly the MSL 320. The interlayer 322 may comprise one or more non-magnetic materials that may serve to reduce magnetic interactions between the SUL 318 and MSL 320 and a base layer 312 (discussed below) and may serve to optimize microstructural and magnetic properties of the hard recording layer.

The interlayer 322 may aid in optimizing media performance. For example, in magnetic recording media, the interlayer 322 may be used to control the crystallographic orientation, grain size, and grain distribution of the base layer 312. The interlayer 322 may also reduce exchange coupling between magnetically hard recording layers and magnetically soft layers. It is appreciated that the interlayer 322 may provide physical separation between adjacent grains of the base layer 312, in one embodiment.

A base layer 312 may be a layer that is established above the MSL 320. Magnetic recording islands 314 are recording areas that are established in the base layer 312. The magnetic recording islands 314 may be established to have an easy magnetization axis (e.g., the c-axis) that is oriented perpendicular to the surface of the magnetic recording medium 400. Magnetic recording islands 314 may be formed from material including cobalt-based alloys with a hexagonal close packed (hcp) structure. Cobalt may be alloyed with elements such as chromium (Cr), platinum (Pt), ruthenium (Ru), boron (B), niobium (Nb), tungsten (W) and tantalum (Ta), to name a few.

The magnetic recording medium 300 may also include a protective layer (not shown) on top of the base layer 312. The protective layer may comprise carbon layer, and a lubricant layer may be disposed over the protective layer. These protective layers may reduce damage from the read/write head interactions with the recording medium during start/stop operations. The magnetic recording medium 300 may include additional layers not shown or described. For example, there may be an adhesion or buffer layer between the substrate layer 316 and the SUL 318. A buffer layer may be established from elements such as Tantalum (Ta).

According to some embodiments, the MSL 320 may comprise at least one material with an hcp lattice structure and may have in-plane (or longitudinal) magnetic anisotropy. An hcp lattice structure with in-plane magnetic anisotropy may be established when a thin layer is formed or grown on the SUL 318. For example, the growth of a layer thickness of 1-300 Å may result in an hcp material with in-plane net magnetic anisotropy. Subsequent layers of the hcp material, that may constitute the MSL 320, may be grown with thickness of 50-100 Å or 1-300 Å upon each previous layer. Further layers may then be grown or deposited over the MSL 320.

The MSL 320 may partially or completely replace at least one interlayer. For example, MSL 206 and interlayer 208 of FIG. 2 may be replaced by MSL 320. For example, the magnetic recording medium 300 may no longer include the interlayer 208 of FIG. 2, but instead may only include the one interlayer 322 along with the MSL 320.

By forming the MSL 320 by an hcp material, the range of materials that may be used in the MSL 320 may be significantly increased. In addition, the use of hcp materials in the MSL 320 may provide an effective template for growing consequently deposited hcp interlayers and/or magnetic layers. Further, the use of hcp materials in the MSL 320 remedies the limitations of fcc magnetic seed layers, which generally have low anisotropy magnetic fields (Hₖ), limited ranges of magnetic permeability (μ), and saturated magnetic flux densities (Bₛ).

The SUL 318 may be amorphous with in-plane magnetic anisotropy while the MSL 320 may be crystalline with in-plane magnetic anisotropy. Accordingly, the MSL 320 and SUL 318 may have matching magnetization orientations.

Similar to the SUL 318, the MSL 320 may also serve to guide magnetic flux, at least partially or substantially completely. For example, the MSL 320 may allow the magnetic flux 309 emanating from the write pole 304 to enter and travel longitudinally or horizontally within the MSL 320, thereby enhancing writability. In addition, the magnetic flux lines 308 that predominantly travel in a longitudinal direction within the SUL 318 may encounter less resistance to flux propagation when travelling vertically through the MSL 320 to and from the SUL 318.

As a result, the head keeper spacing (HKS) (the gap between the write pole 304 and the SUL 318) may effectively be reduced since the MSL 320, which may allow the travel of magnetic flux lines like the SUL 318, may be closer to the write pole 304, thereby increasing writability. For example, the HKS of magnetic recording medium 200 of FIG. 2 may be larger than the HKS of the magnetic recording medium 300 of FIG. 3. The head media spacing (HMS) (the distance between the magnetic writer head and the magnetic recording layer, including overcoats and lubricating coats on either head or recording layer) may or may not be affected. For example, the thickness of the MSL 320 of FIG. 3 may be less than the combined thickness of the MSL 207 and the interlayer 208 of FIG. 2. Such a dual usage of the MSL 320 may decrease the number of sputtering stations used during manufacturing of the storage disks.

The MSL 320 may be formed from materials with out-of-plane magneto-crystalline anisotropy. For example, the MSL 320 may be formed by Co—Cr—X with out-of-plane magneto-crystalline anisotropy. Although the hcp MSL 320 may have perpendicular uniaxial magneto-crystalline anisotropy, its magnetization vector may remain in-plane when thin films of such materials are deposited on an amorphous SUL. For materials with (Hₖ)/(4πMₛ) less than one to slightly larger than 1 (where Mₛ is the saturation magnetization), the shape anisotropy of the thin film and the ferromagnetic coupling to the SUL makes the magnetization vector lie in the film plane. Consequently, such hcp materials may behave like pseudo-soft magnetic materials as part of the SUL without introducing magnetic noise to a system. At the same time, such hcp materials can provide good epitaxial growth properties to a subsequent layer.

For example, Co—12Cr—15Ru is a magnetic material that grows with an hcp structure. This material has a Bₛ˜0.4 T, Hₖ˜5.6 kOe, and Mₛ ˜320 emu/cc. When this material is grown by itself on an adhesion layer, it has a uniaxial out-of-plane anisotropy and a ratio (Hₖ)/(4πMₛ)˜1.39, resulting in an out-of-plane magnetic anisotropy.

When a thin layer of Co—12Cr—15Ru, for example with a thickness ranging between 1 Å and 300 Å, is deposited on another MSL or directly on an amorphous SUL, this material behaves differently. In this case, the thin film shape anisotropy along with the ferromagnetic coupling between the hcp MSL and the SUL (with in-plane anisotropy) maintains the magnetization within the film plane. Analysis of the longitudinal (in-plane) and perpendicular (out-of-plane) magnetization (M) versus applied magnetic field (H) loops illustrates this behavior. It is appreciated that the MSL 320 may be strongly coupled to the SUL 318 if 100 Å or less are grown directly on the SUL 318 that is 200 Å.

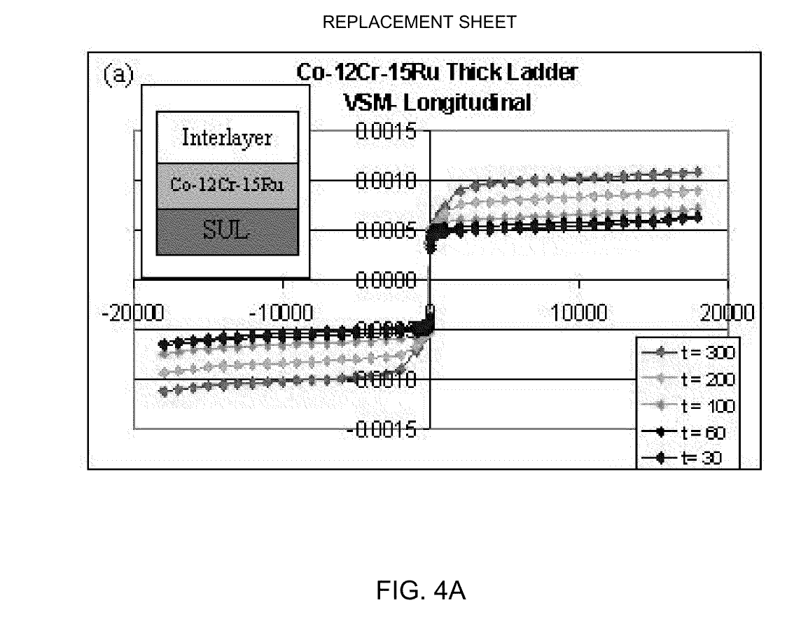

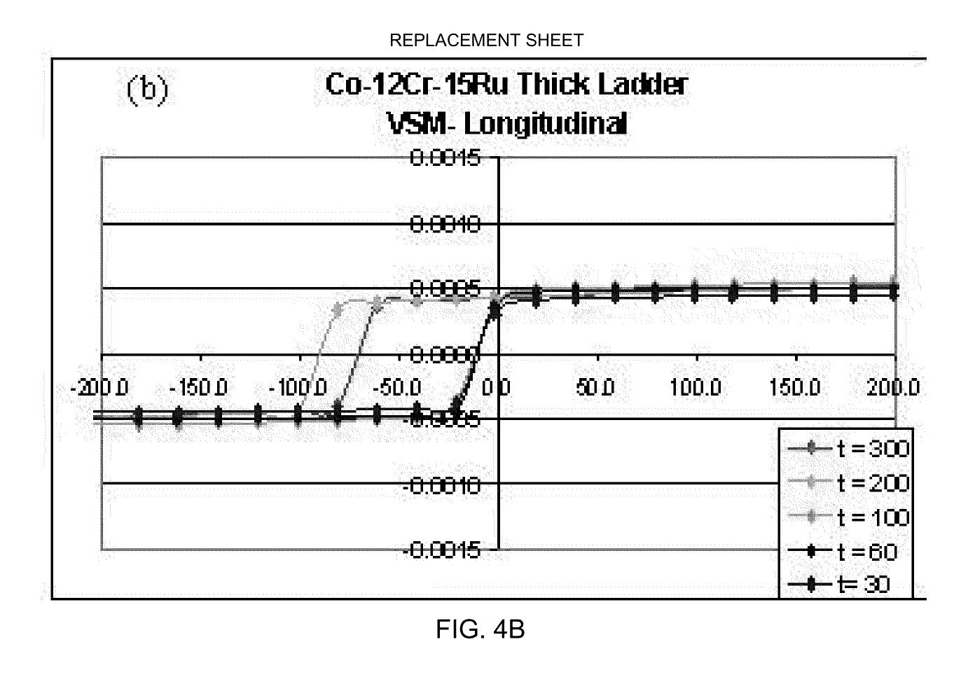

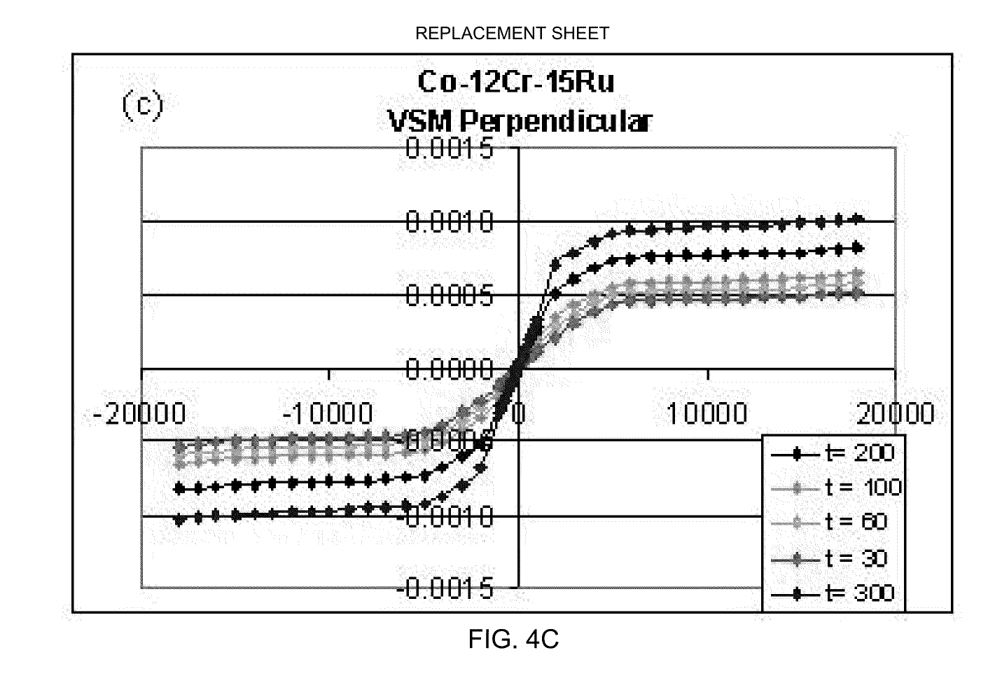

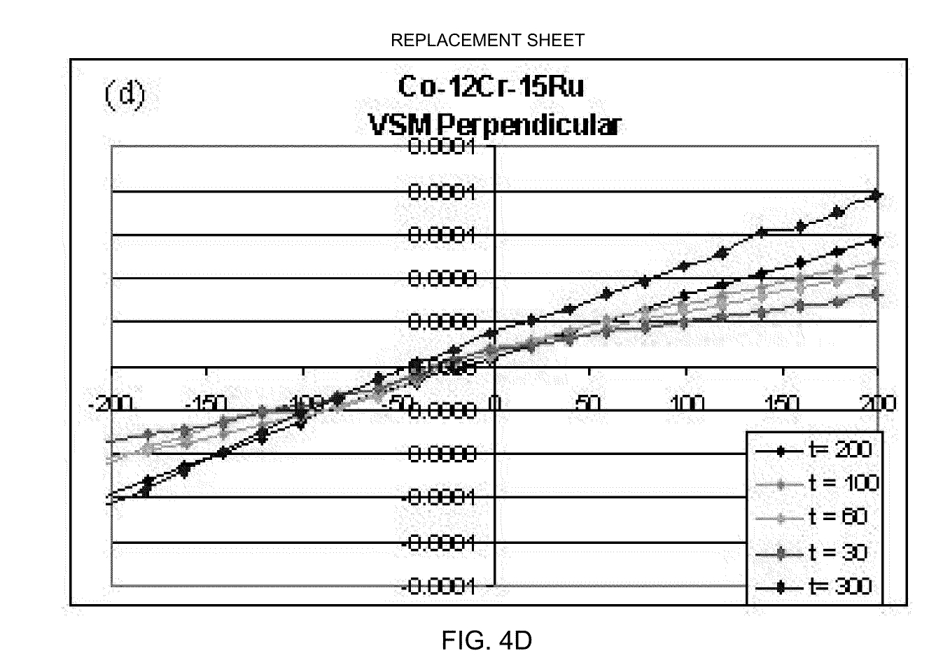

FIGS. 4a-d show exemplary graphical views of a vibrating sample magnetometer (VSM) M-H loops of Co—12Cr—15Ru grown on a soft underlayer in accordance with one embodiment. Specifically, FIGS. 4a-d illustrate M (emu/cc) versus H (Oe) loops taken by the VSM. FIG. 4a includes a longitudinal measurement (in-plane), where the loops are more square and have steep tangents at their point of transition. The inset illustrates the structure of the studied system. FIG. 4b includes a change of scale, where longitudinal loops show coercivity. FIG. 4c includes perpendicular measurements (out-of-plane). FIG. 4d includes a change of scale, where t is the Co—12Cr—15Ru layer thickness.

High-coercivity, for example 20 Oe-100 Oe, is present in the longitudinal measurement shown in FIG. 4b. This is the characteristic of the M-H loop of an in-plane magnetic anisotropy material. Most importantly, when a magnetic field is applied perpendicular to the film plane, there is no hysteresis in the M-H loop. This indicates that the film behaves like SUL with its magnetization lying in the film plane.

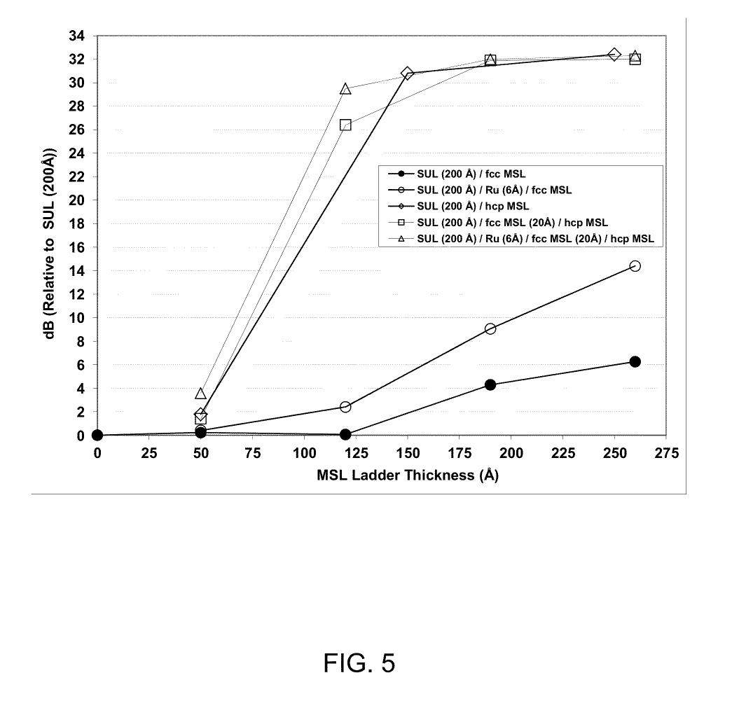

FIG. 5 is graphical view of the noise levels of Co—Cr—Ru, in accordance with one embodiment. Specifically, FIG. 5 illustrates integrated magnetic noise (dB) versus MSL thickness (A), where the SUL is a Fe—Co—Cr—B alloy, the hcp MSL is a Co—Cr—Ru alloy, and the fcc MSL is a Ni—Co—W—Cr alloy. The thickness of each layer is shown in the parentheses and some of the MSL are antiferromactically coupled to the SUL through the Ru layer. The noise is measured by flying a recording head or reader on top of the film shown in the inset of FIG. 4a. When there is a large quantity of magnetic domain walls, or out-of-plane magnetization components, the head will pick the random magnetization variation (noise). For films thinner than 50 Å, the noise level is comparable to that of a Ni-based fcc MSL. This demonstrates that at least 50 Å of the proposed materials may be used as MSL. It is appreciated that an acceptable noise level may be comparable to that of a fcc MSL.

In a separate media recording performance test, where 85% of the Ni-based fcc MSL was replaced by Co-12Cr-15Ru, the recording performance was comparable or increased compared to the controlled samples of 100% Ni-based fcc MSL at the same magnetic write width (MWW). It is appreciated that this new MSL has a gain in reverse overwrite (Rev_OW) by 2-3 dB, indicating increased writability.

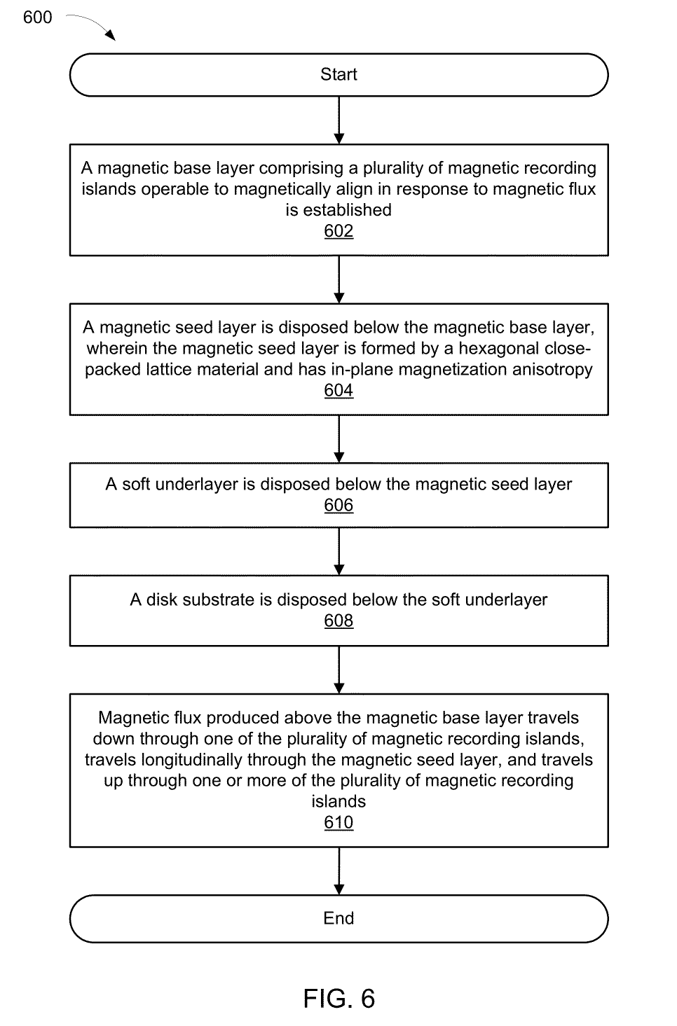

FIG. 6 depicts a flowchart 600 of an exemplary process of operating a storage medium with a magnetic seed layer, according to an embodiment. In a block 602, a magnetic base layer comprising a plurality of magnetic recording islands operable to magnetically align in response to magnetic flux is established. For example, in FIG. 3, a magnetic base layer including magnetic recording islands operable to magnetically align in response to magnetic flux is established.

In a block 604, a magnetic seed layer is disposed below the magnetic base layer, wherein the magnetic seed layer is formed by a hexagonal close-packed lattice material and has in-plane magnetization anisotropy. For example, in FIG. 3, a magnetic seed layer is formed by a hexagonal close-packed lattice material and has in-plane magnetization anisotropy.

In some embodiments, the magnetic seed layer is between 10-100 Å thick. In further embodiments, the magnetic seed layer comprises a plurality of growth layers. It is appreciated that each growth layer may be between 10-100 Å thick. In one embodiment, an interlayer is disposed between the magnetic base layer and the magnetic seed layer.

In various embodiments, magnetic seed layer is operable to allow longitudinal passage of magnetic flux generated by a read/write pole. For example, in FIG. 3, the magnetic seed layer allows the horizontal or longitudinal passage of magnetic flux produced by the read/write pole of the head.

In a block 606, a soft underlayer is disposed below the magnetic seed layer. For example, in FIG. 3, a soft underlayer is disposed below the magnetic seed layer. In various embodiments, the soft underlayer is operable to allow passage of magnetic flux. In some embodiments, the soft underlayer is amorphous and has in-plane magnetic anisotropy.

In a block 608, a disk substrate is disposed below the soft underlayer. For example, in FIG. 3, a disk substrate is disposed below the soft underlayer.

In a block 610, magnetic flux produced above the magnetic base layer travels down through one of the plurality of magnetic recording islands, travels longitudinally through the magnetic seed layer, and travels up through one or more magnetic recording islands of the plurality of magnetic recording islands. For example, in FIG. 3, the magnetic flux 309 travels down through one of the magnetic recording islands, travels longitudinally through the magnetic seed layer, and travels up through one or more of the magnetic recording islands.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. An apparatus comprising:
a substrate;
a soft underlayer overlying said substrate; and
a magnetic seed layer overlying said soft underlayer, wherein said magnetic seed layer is formed from a hexagonal close-packed crystalline structure, having longitudinal magnetization, and wherein said magnetic seed layer is permeable by magnetic flux.

2. The apparatus of claim 1, wherein a thickness of said magnetic seed layer ranges between 10-100 Å.

3. The apparatus of claim 1, wherein said magnetic seed layer comprises a plurality of growth layers, wherein each growth layer of said plurality of growth layers is between 10-100 Å thick.

4. The apparatus of claim 1, wherein said magnetic seed layer and said soft underlayer are operable to pass magnetic flux in horizontal direction.

5. The apparatus of claim 1, wherein said soft underlayer is amorphous and has in-plane magnetic anisotropy.

6. The apparatus of claim 1 further comprising a magnetic base layer disposed above said magnetic seed layer.

7. The apparatus of claim 1, wherein said interlayer is operable to substantially prevent magnetic interactions between the soft underlayer and said magnetic seed layer and said magnetic base layer to optimize microstructural and magnetic properties of hard recording layer.

8. An apparatus comprising:
a magnetic base layer, wherein said magnetic base layer comprises a plurality of magnetic recording islands operable to magnetically align in response to a magnetic flux;
a magnetic seed layer disposed below said magnetic base layer, wherein said magnetic seed layer is formed by a hexagonal close-packed lattice material, having in-plane magnetic anisotropy, and wherein said magnetic seed layer is operable to pass said magnetic flux longitudinally, wherein said magnetic flux is produced by a read/write pole; and
a soft underlayer disposed below said magnetic seed layer.

9. The apparatus of claim 8, wherein a thickness of said magnetic seed layer ranges between 10-100 Å.

10. The apparatus of claim 8, wherein said magnetic seed layer comprises a plurality of growth layers, wherein each growth layer of said plurality of growth layers is between 10-100 Å thick.

11. The apparatus of claim 8, wherein said soft underlayer is operable to pass said magnetic flux.

12. The apparatus of claim 8, wherein said soft underlayer is amorphous and has in-plane magnetic anisotropy.

13. The apparatus of claim 8 further comprising an interlayer disposed between said magnetic base layer and said magnetic seed layer.

14. An apparatus comprising:
a soft underlayer; and
a magnetic seed layer overlying said soft underlayer, wherein said magnetic seed layer is formed from a hexagonal close-packed lattice material having in-plane magnetic anisotropy.

15. The apparatus of claim 1, wherein a thickness of said magnetic seed layer ranges between 10-100 Å thick.

16. The apparatus of claim 1, wherein said magnetic seed layer comprises a plurality of growth layers, wherein each magnetic growth layer of said plurality of growth layers is between 10-100 Å thick.

17. The apparatus of claim 1, wherein said magnetic seed layer is operable to pass magnetic flux in horizontal direction.

18. The apparatus of claim 1, wherein said soft underlayer has an in-plane magnetic anisotropy, wherein said soft underlayer is operable to pass a magnetic flux through, and wherein said magnetic seed layer is operable to pass a magnetic flux through.

19. The apparatus of claim 1 further comprising:
an interlayer overlying said magnetic seed layer; and
a magnetic base layer overlying said interlayer.

20. The apparatus of claim 6, wherein said interlayer is operable to substantially prevent magnetic interactions between the soft underlayer and said magnetic seed layer and said magnetic base layer.
